(19) United States
(12) Patent Application Publication
(10) Pub. No.: US 2005/0038685 A1
(43) Pub. Date: Feb. 17, 2005

(54) System and method for delivery of goods during epidemic

(76) Inventor: Kenneth A. Collins, Mission Viejo, CA (US)

Correspondence Address: John L. Rogitz, Esq.;ROGITZ & ASSOCIATES, Suite 3120, 750 "B" Street, San Diego, CA, 92101, US

(21) Appl. No.: 10/641,439

(22) Filed: Aug. 15, 2003

(51) Int. Cl. G06F 17/60

(52) U.S. Cl. 705/8; 705/14

(57) ABSTRACT

Goods are delivered to recipients during, e.g., isolation or quarantine during an epidemic such as SARS such that the contents of a package, once sterile, remain sterile until opened. Also, the external surface of the package remains free of infectious agents since it is not touched by anyone after sterilization other than the intended recipient. To do this, delivery personnel do not have to touch or otherwise interact with the distribution system in a way that could contaminate the packages through direct or indirect contact.

### I. FIELD OF THE INVENTION

The present invention relates generally to delivery systems.

### II. BACKGROUND OF THE INVENTION

The global SARS outbreak has caused concern among health officials because the virus is infectious, the disease can spread via direct contact with infected people or the aerosol of their secretions or indirectly via contact with surfaces contaminated with human secretions, and the incubation period of the disease is sufficiently long that a person may not recognize the contact by which they become ill. Moreover, the disease has no known cure or vaccine and is highly lethal. Consequently, the management of the disease consists of the isolation and supportive care of infected persons. This pattern of management will not change until such time as there is developed a vaccine or cure.

Initial experience with the disease indicates that once hospitals are saturated with patients, they become points of high contact and contamination of health care workers leads to further spread of the virus. The influenza viral pneumonia outbreak of 1919 demonstrates the almost inevitable result for SARS if the primary containment attempts fail and/or a vaccine or cure cannot be developed.

The spread of the virus is as a linear network. A small number of individuals will be highly infectious either because of the high load of viral particles that they shed and/or via the high rate of contact that they have with others. In seeking to prevent spread via isolation, large sections of the population, both the healthy and those living with the infection or the infected, will have to be isolated from one another. Even without legally enforced isolation, sections of the community may seek to isolate themselves to prevent entry of the virus. The present invention understands that for this isolation to be effective, it must be possible to ensure the provision of foodstuffs and other essentials so that individuals are not forced to break down the isolation to survive.

As recognized herein, the movement of goods across the community is attended by personal transportation of goods and via the organized distribution of goods by contracted carriers. Either form of the movement of goods provides a vector for the rapid spread of the virus and must be minimized. The present invention accordingly understands that the avoidance of person-to-person contact and goods-to-person contact is essential.

Current processes of distribution are focused on the rapid receipt, identification, transport and delivery of goods. The focus of the packaging and transport is the protection of the contents from external damage. The packaging itself is an anti-soil covering and an anti-tamper barrier. However there is much human handling of the packages and no effort is undertaken to ensure that the contents and the outside of the package are free of contagions upon delivery.

### SUMMARY OF THE INVENTION

Goods can be broadly categorized into those than can be made non-infectious without loss of function and those that cannot. The present invention is directed to distributing goods that can be made non-infectious without such degradation of their essential nature as to be rendered unserviceable by the process. Accordingly, a method for the distribution of goods such that isolation is not compromised by their distribution is disclosed herein.

In one aspect, a method for providing customers with uncontaminated goods includes, once an epidemic has been identified and customers voluntarily or forcibly prevented from travelling to a vendor location, disposing the goods in a container under sterile conditions, such that the goods remain substantially uncontaminated. The method also includes disposing the container in a delivery vehicle such that the container remains substantially uncontaminated. The container is removed from the delivery vehicle at a customer location while maintaining a sanitation barrier between the container and a driver of the deliver vehicle.

In a preferred embodiment, the step of disposing the goods in a container can include requiring personnel to wear protective sanitation clothing when packing the goods. It can further include packing the goods in packages within a sanitized room. Package identifiers may be applied to at least some packages and/or containers so that the method can include using a computerized tracking system that uses, e.g., bar codes.

Preferably, the method includes sanitizing packages after packing, and then loading packages into the container, with the container being sterile.

The packages can be offloaded from the delivery vehicle manually by a person in protective sanitation clothing. More preferably, it is undertaken remotely using a conveyor system mounted on the vehicle. The method may also include informing a customer when goods have been delivered.

In another aspect, a system for providing customers with uncontaminated goods includes plural sterile containers bearing goods, and an internally sterile delivery vehicle for transporting the containers such that the goods remain substantially uncontaminated. The system further includes a conveyor system on the delivery vehicle for offloading goods at destinations while maintaining a sanitation barrier between the goods and a driver of the deliver vehicle.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a flow chart of the present process; and

FIG. 2 is a schematic diagram of a system for undertaking the process shown in FIG. 1.

### DETAILED DESCRIPTION OF THE PREFERRED EMBODIMENT

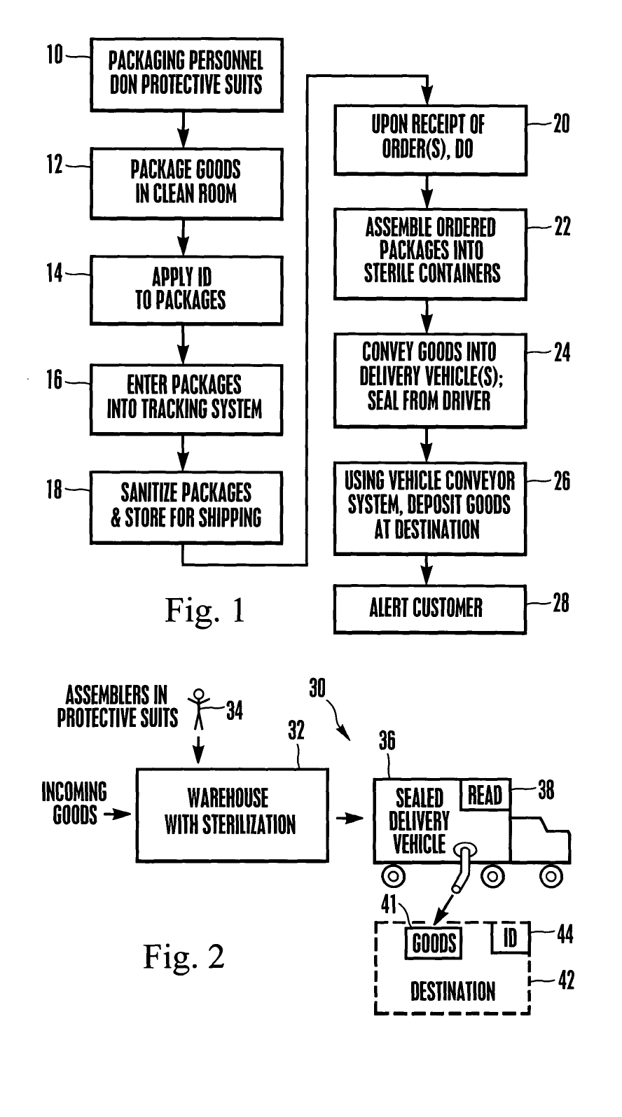

Referring initially to FIG. 1, the present process for delivering goods to customers who might be quarantined electively or otherwise during an epidemic such that the goods cannot be contaminated until touched by the intended recipients begins at block 10, wherein packaging personnel at a distribution center don protective clothing. By “protective clothing” or “protective sanitation clothing” is meant clothing such as manufacturing clean room clothing or other clothing that provides a total sanitation barrier between the wearers and the items they handle or work around without infection to or from the handlers.

Moving to block 12, goods to be delivered (such as but not limited to foodstuffs) are packaged into appropriately configured packages in a clean room. At block 14, an identification mark, sticker, tag, or other identifying article is placed on each package in such a way that the contents of the package can be described sufficient to ensure identification. The identification can include bar code data representing the quantity and quality of the contents, the packaging date and use by date, if any, the nature of the storage requirements for the contents, and any special handling requirements for the package.

Proceeding to block 16, each package is entered into a computerized tracking system. Bar code readers or other detectors can track the packages such that for each package, its location, intended destination, intended routing stops to the destination, etc. can be known.

At block 18, viral Clearance and warehousing is undertaken by sanitizing the packages in accordance with sanitation techniques known in the art, including, e.g., steam sterilization, gamma irradiation, ultra-violet light exposure, and ethylene oxide sterilization. Once cleaned of contagions, the packages can be moved to a store room by personnel in full protective suits. The store room preferably is equipped with high flow positive pressure filtered air. Methods preferably are employed to ensure that there is no external contamination of the packages (e.g. ultraviolet lights, alcohol wipes etc).

Block 20 indicates that a DO loop is entered to assemble ordered packages into containers upon receipt of an order. Orders preferably are received by means (facsimile, email, telephone) that do not require exposure of the personnel receiving them to the contagion. The above-mentioned computerized tracking system allows the production of a “pick list” of the required goods in an order. The order is then assembled and placed into sterile containers from a range of containers of varying size. In some cases conforming wrapping may be applied.

In the preferred embodiment, each order has a bar code that allows the identification of each object and the information required for delivery. Accordingly, proceeding to block 22, ordered packages are assembled into containers based on, e.g., proximity of delivery destinations, preferably by suited personnel and electro-mechanical systems so as to prevent the spread of contagion to the surface of the packages and damage to the contents of the packages. Appropriate identifying codes are placed on the outside surface of the containers, as was done in the case of the packages.

Moving to block 24, the containers are shipped to their destinations. In some cases goods will be received for through shipment i.e., they will be received with a recipient already known and the goods typically be contracted to go from sender to recipient. Passage through the present method ensures that contagion is not spread via the transport of the goods. Each package/container has a bar code that allows the identification of each object and the information required for delivery, and the containers are sealed from the drivers of the delivery vehicles.

To do this, packages and/or containers can be moved by conveyor systems into trucks or other delivery vehicles. The vehicles are sealed so that the driver cannot either spread or become exposed to the contagion from inside his vehicle. This may be done alternatively by sealing the driver in a protective suit.

The preferred delivery vehicles are fitted with an apparatus that allows the ejection, at block 26, of any package or of any container from within the vehicle outside the vehicle once at the delivery point in such a manner that ensures that the contents of the package are not damaged and the package is itself not breached. The ejection mechanism could be any one of a remote controlled crane and armature, a sequential conveyor or slide system, a set of independent containers with hatches, and so on. The preferred features of the mechanism is that it can be rapidly and fully cleaned of contagion once empty, it can deliver the packages/containers to the foot path, receiving platform or mail box-like receiving container from the road way, water way or railway of the delivery vehicle, and delivery can occur without direct human contact. Moreover, contagion of the packages/containers from the outside of the vehicle should not be possible except at the moment that they are ejected form the vehicle.

Once delivered, in most cases to a pre-arranged location, at block 28 the customer is alerted and billed. The recipient customer is responsible for collecting and processing for his/her own use the package. Any of the normal methods of announcing the delivery can be employed (e.g. horn, telephone call, email). Where “signed receipt” of goods is required, the vehicle can have mounted on its exterior a camera and recording device that allows a recipient to record his/her face, or voice, etc. The camera can be mounted behind a self cleaning protective and transparent plate. Alternative methods of acknowledging receipt may be employed provided that they do not involve the touching of surfaces that will come into contact with personnel managing the system, other customers or the delivery vehicle.

FIG. 2 schematically illustrates a system 30 that can include a sterile warehouse or clean room 32 in which packaging workers 34 in protective clothing process goods in accordance with the method above. The goods (in packages/containers) are loaded into a sealed delivery vehicle 36 that can have a bar code reader 38 mounted on it, as well as other sensors, such as the above-mentioned camera. The delivery vehicle 36 has a conveyor 40 in accordance with the above disclosure that offloads packages/containers 41 at their respective destinations 42. A destination 42 can include an identification sign 44 that can be read by the reader 38 to verify that the location to which the goods are being delivered is the location indicated on the packages/containers.

While the particular SYSTEM AND METHOD FOR DELIVERY OF GOODS DURING EPIDEMIC as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconciliable with the present specification and file history.

1. A method for providing customers with uncontaminated goods, comprising:
identifying an epidemic resulting in customers voluntarily and/or forcibly being prevented from travelling to a vendor location;
disposing the goods in a container under sterile conditions, such that the goods remain substantially uncontaminated;
disposing the container in a delivery vehicle such that the container remains substantially uncontaminated; and
removing the container from the delivery vehicle at a customer location while maintaining a sanitation barrier between the container and a driver of the deliver vehicle.

2. The method of claim 1, wherein the step of disposing the goods in a container comprises requiring personnel to wear protective sanitation clothing when packing the goods.

3. The method of claim 1, wherein the step of disposing the goods in a container comprises packing the goods in packages within a sanitized room.

4. The method of claim 1, wherein package identifiers are applied to at least some packages and/or containers.

5. The method of claim 1, comprising tracking containers using a computerized tracking system.

6. The method of claim 5, wherein the system uses bar codes.

7. The method of claim 1, comprising sanitizing packages after packing.

8. The method of claim 1, comprising packing goods into packages and then loading packages into the container, the container being sterile.

9. The method of claim 1, wherein the removing act is undertaken manually by a person in protective sanitation clothing.

10. The method of claim 1, wherein the removing act is undertaken remotely using a conveyor system mounted on the vehicle.

11. The method of claim 1, comprising informing a customer when goods have been delivered.

12. A system for providing customers with uncontaminated goods, comprising:
plural sterile containers bearing goods;
at least one internally sterile delivery vehicle for transporting the containers such that the goods remain substantially uncontaminated; and
a conveyor system on the delivery vehicle for offloading goods at destinations while maintaining a sanitation barrier between the goods and a driver of the deliver vehicle.

13. The system of claim 12, comprising package identifiers applied to at least some packages and/or containers.

14. The system of claim 12, comprising means for tracking containers using a computerized tracking system.
